(19) United States
(12) Patent Application Publication
(10) Pub. No.: US 2008/0241310 A1
(43) Pub. Date: Oct. 2, 2008

(54) Injection mold with a quick-change apparatus

(76) Inventors: Chih-Yu Chen, Tu-Cheng City (TW); Jian-Guang Huang, Tu-Cheng City (TW); Yun-Ging He, Tu-Cheng City (TW); Chun-Yan Wu, Tu-Cheng City (TW); Lin-Chong Zhu, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/727,307

(22) Filed: Mar. 26, 2007

(51) Int. Cl. B29C 33/30

(52) U.S. Cl. 425/556

(57) ABSTRACT

An injection mold with a quick-change apparatus includes a top clamping plate, a cavity plate, a core plate, a core plate frame, an ejector mechanism and a bottom clamping plate. The core insert and the ejector mechanism are defined between the core plate and the core plate frame. A plurality of connecting rods are defined between the core insert and the ejector plates, one end of the connecting rod received in the passageway of the ejector plate, the other end of the connecting rod fixed in the cavity of the core insert to enable the ejector plate and the ejector ret plate to move up and down and connect with the connecting rod all long. So the ejector mechanism and the core insert are connected together, and can be changed together.

### BACKGROUND OF THE INVENTION

1. Field of the Invention

The present invention relates to an injection mold, and more particularly to an injection mold with a quick-change apparatus for core insert and ejector mechanism.

2. The Related Art

Please refer to FIG. 1, a conventional injection mold comprises a top clamping plate 11, a cavity plate 12, a core plate 14, a core plate frame 15, an ejector mechanism and a bottom clamping plate 16. The ejector mechanism includes an ejector ret plate 21, an ejector plate 20 and a plurality of ejector pins (not shown).

However, when the product is changed, the ejector mechanism and the core insert of the mold should be changed respectively, that is a waste of time and brings some troubles. Therefore, it is necessary to develop a mold, the ejector mechanism and the core insert of which could be changed quickly and conveniently.

### SUMMARY OF THE INVENTION

An object of the present invention is to provide an injection mold with a quick-change apparatus. The injection mold includes a top clamping plate; a cavity plate arranged under the top clamping plate; a core plate arranged under the cavity plate; a core plate frame arranged under the core plate; a core insert located in the core plate; an ejector mechanism arranged in the core plate frame, having an ejector ret plate and a ejector plate being fixed together; and a bottom clamping plate arranged under the core plate frame; wherein a plurality of connecting rods are defined between the core insert and the two ejector plates, one end of the connecting rod is received in the ejector plate and the ejector ret plate, and the other end is fixed in the core insert to enable the ejector plate and the ejector ret plate to move up and down and connect with the connecting rod all long.

As described above, the ejector mechanism and the core insert are connected together as a quick-change apparatus, therefore, the ejector mechanism and the core insert can be changed together when the ejector mechanism and the core insert are needed to be changed.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a conventional injection mold;

FIG. 2 is a cross sectional view of an injection mold with a quick-change apparatus of the present invention;

FIG. 3 is a perspective view of an ejector mechanism and a core insert according to the present invention;

FIG. 4 is a cross-sectional view of FIG. 3;

FIG. 5 is a perspective view of FIG. 4 without connecting rods; and

FIG. 6 is a perspective view of the connecting rod.

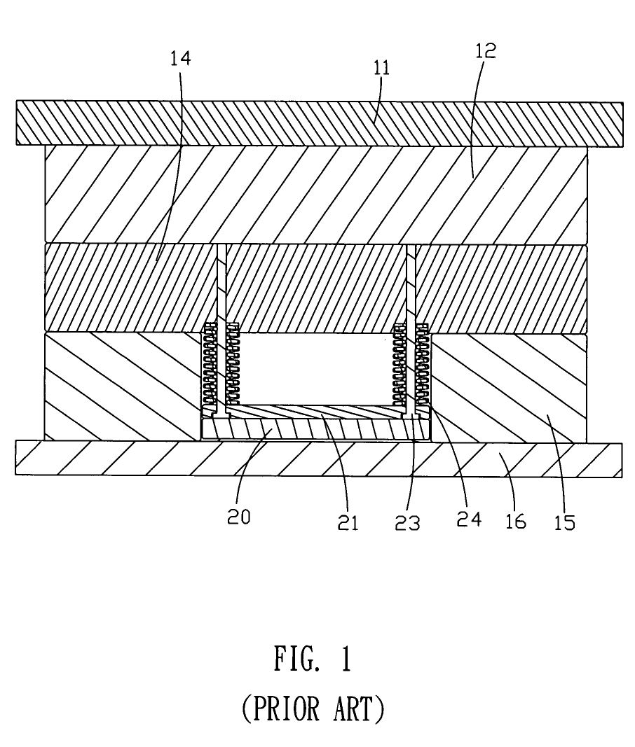

### DETAILED DESCRIPTION OF THE PREFERRED EMBODIMENT

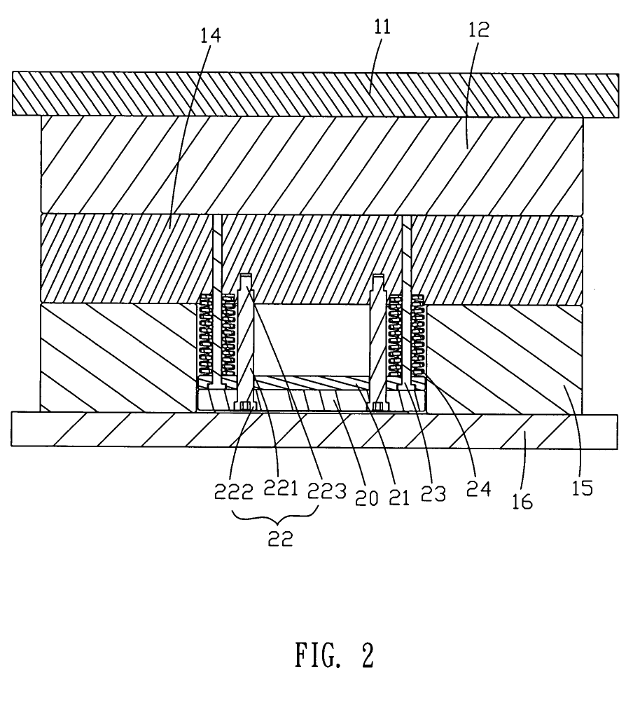

With reference to FIG. 2, an injection mold with a quick-change apparatus includes a top clamping plate 11, a cavity plate 12, a core plate 14, a core plate frame 15, an ejector mechanism and a bottom clamping plate 16.

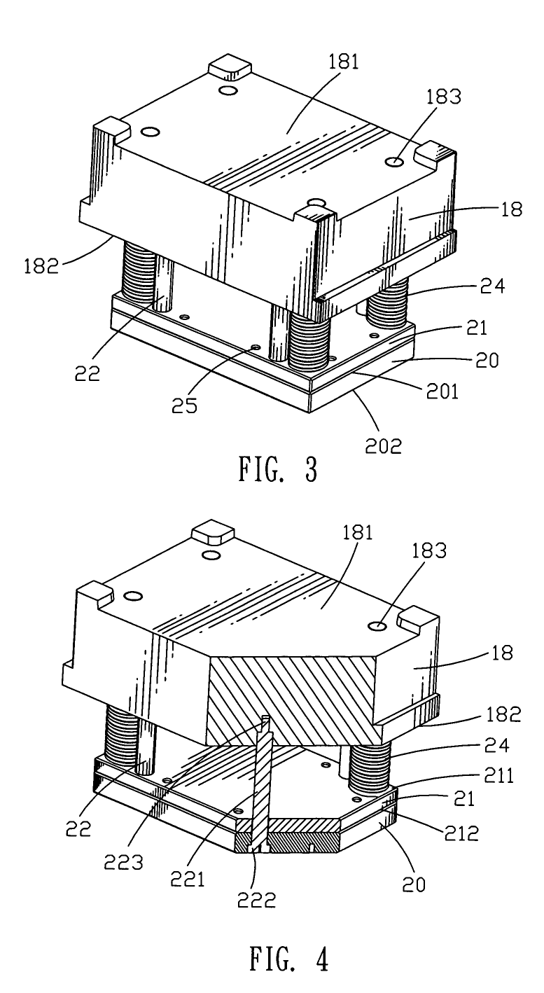

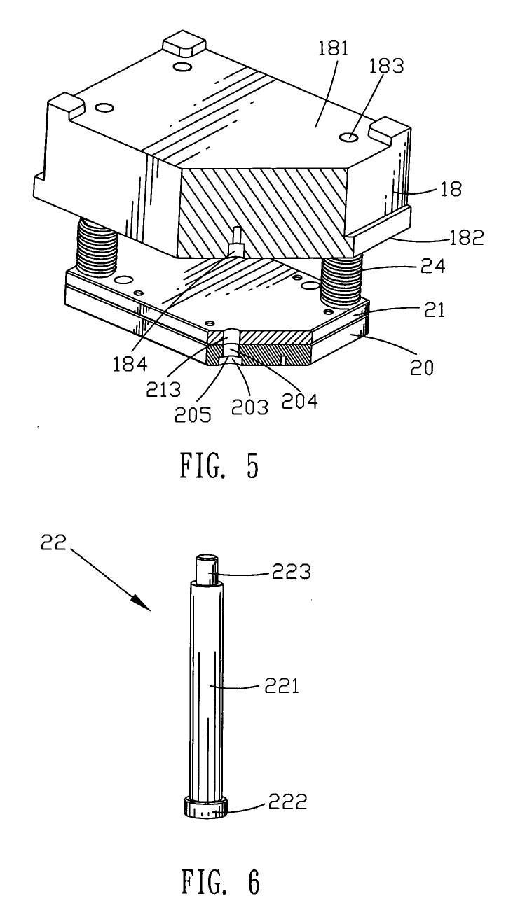

Referring to FIG. 3, the ejector mechanism includes an ejector ret plate 20, an ejector plate 21, and a plurality of ejector pins (not shown). A plurality of screws 25 fix the ejector ret plate 20 and the ejector plate 21 together.

Referring to FIGS. 2-4, the ejector plate 20 is in an oblong shape, which has a top surface 201 and a bottom surface 202. A plurality of first chambers 203 are defined at the bottom of the ejector plate 20 and a plurality of second chambers 204 communicating with the corresponding first chambers 203 are defined at the top of the ejector plate 20. The first chamber 203 is wider than the second chamber 204, so a blocking surface 205 is formed where the first chamber 203 communicating with the second chamber 204.

The ejector ret plate 21 is in an oblong shape, having a top surface 211 and a bottom surface 212 opposing to the top surface 211. The bottom surface 212 of the ejector ret plate 21 faces to the ejector plate 20. A plurality of third chambers 213 are defined through the ejector ret plate 21 corresponding to the first and second chambers 203, 204 of the ejector plate 20, so the corresponding first, second and third chamber 203, 204, 205 are consisted of a passageway.

The core insert 18 is approximately of an oblong configuration, having a first surface 181 and a second surface 182. Four holes are defined at four comers of the core insert 18. Accordingly, four reject pins 23 are disposed in the holes of the core insert 18 and can slide along the holes of the core insert 18. The bottom end of the reject pin 23 protrudes downwardly from the second surface 182 of the core insert 18 and is fixed at a comer of the ejector ret plate 21. The portion of the reject pin 23 between the core insert 18 and the ejector ret plate 21 is wrapped in a spring 24. A plurality of cavities 184 corresponding to the passageways are defined at the second surface 182.

Please referring to FIG. 4 and FIG. 6, a plurality of connecting rods 22 are defined between the core insert 18 and the two ejector plates 20, 21. The connecting rod 22 has a connecting portion 221 of a column configuration. The bottom end of the connecting portion 221 protrudes downwardly to form a restricting portion 222 being wider than the connecting portion 221, and the top end of the connecting rod 22 protrudes upwardly to form a locating portion 223 being narrower than the connecting portion 221. The restricting portion 222 is disposed in the second chamber 204 of the ejector ret plate 21. The connecting portion 221 passes through the passageway of the ejector ret plate 21 and the ejector plate 20 and then extends into the cavity 184 of the core insert 18. The locating portion 223 is fixed in the cavity 184 of the core insert 18. The two ejector plates 20, 21 can slide along the connecting rod 22 and can't move away from the connecting rod 22 by the blocking surface 205 limiting the restricting portion 222

In a word, a plurality of connecting rods 22 are defined between the core insert 18 and the two ejector plates 20, 21 to connect the core insert 18 and the ejector mechanism together as a quick-change apparatus. So the ejector mechanism and the core insert 18 can be changed together when the ejector mechanism and the core insert 18 are needed to be changed, and that saves time.

What is claimed is:

1. An injection mold with a quick-change apparatus comprising:
a top clamping plate;
a cavity plate arranged under the top clamping plate;
a core plate arranged under the cavity plate;
a core plate frame arranged under the core plate;
a core insert located in the core plate;
an ejector mechanism arranged in the core plate frame, having an ejector ret plate and a ejector plate being fixed together; and
a bottom clamping plate arranged under the core plate frame;
wherein a plurality of connecting rods are defined between the core insert and the two ejector plates, one end of the connecting rod is received in the ejector plate and the ejector ret plate, and the other end is fixed in the core insert to enable the ejector plate and the ejector ret plate to move up and down and connect with the connecting rod all long.

2. The injection mold with a quick-change apparatus as claimed in claim 1, wherein the ejector ret plate and ejector plate define a plurality of passageways at the corresponding positions together for receiving the connecting rods, accordingly, a plurality of cavities are defined at the corresponding positions of a surface of the core insert for fixing the top of the connecting rods.

3. The injection mold with a quick-change apparatus as claimed in claim 2, wherein the passageway of the ejector plate includes a first chamber and a second chamber communicating with each other in the ejector plate and a third chamber in the ejector ret plate, the first chamber defined at the bottom surface of the ejector plate, the second chamber defined at the top surface of the ejector plate and being narrower than the first chamber, a blocking surface formed between the first and second chambers.

4. The injection mold with a quick-change apparatus as claimed in claim 3, wherein the connecting rod has a connecting portion with a restricting portion wider than the connecting portion protruding from the bottom end of the connecting portion, and a locating portion narrower than the connecting portion protruding from the top end of the connecting portion, the restricting portion restricted at the blocking surface, the locating portion fixed in a cavity of the core insert.
